(19) United States
(12) Patent Application Publication
(10) Pub. No.: US 2010/0036740 A1
(43) Pub. Date: Feb. 11, 2010

(54) SELF SERVICE ADVERTISING METHOD AND SYSTEM

(76) Inventor: Yitshak Barashi, Jerusalem (IL)

Correspondence Address: Marc Van Dyke, 123 N.W. 13th Street, Suite 221, Boca Raton, FL, 33432-1619, US

(21) Appl. No.: 12/581,858

(22) Filed: Oct. 19, 2009

Related U.S. Application Data
(63) Continuation-in-part of application No. PCT/IL2008/000604, filed on Apr. 17, 2008.

(30) Foreign Application Priority Data
Apr. 19, 2009 (IL) IL182702

(51) Int. Cl. G06Q 30/00; G06F 3/048

(52) U.S. Cl. 705/14.71; 705/14.72; 705/14.69; 715/768

(57) ABSTRACT

The invention relates to self service advertising method, which comprises: (a) displaying a web page in a normal mode, wherein the page comprises content and active advertisements that are displayed in specific advertising spaces within the web page; (b) providing the same web page in an advertiser mode, wherein the page is displayed with the same content and content placement as in said normal mode, while those advertising spaces that are offered for future advertising are shown without their active advertisements and in their exact same placement in the document as in said normal mode, and wherein each advertising space comprises at least a link for guiding an advertiser to a process for self placing an advertisement within said advertising space; and (c) a predefined virtual button or link within said web page in both said normal and advertiser modes for effecting switching between said normal and advertiser modes.

### CROSS-REFERENCE TO RELATED APPLICATIONS

This patent application is a continuation-in-part of PCT/IL2008/000533 filed on Apr. 17, 2008 and published as WO/2008/129543, which claims priority to Israeli patent application IL 82702 filed on Apr. 19, 2007 which are both hereby incorporated in their entirety by reference.

### FIELD OF THE INVENTION

The present invention relates to self advertising in the Internet. More particularly, the invention relates to a method for self advertising which involves plurality of visual presentations (visual modes) of web pages (also referred herein as visual modes). More specifically, the method involves having for a same page several modes: a normal mode in which the page is conventionally displayed (i.e., the content and advertisements are displayed), an advertiser mode in which the advertiser can self introduce his advertisement into the page, and a publisher mode for use by the site publisher, wherein entrance into the publisher mode is restricted. Optionally, the advertiser mode also includes display of the page in a simulation mode, in which the page is displayed to the user, including the content, the other advertisements, and a new advertisement at its intended location and exactly as planned to be, for the purpose of verification by the advertiser, before finalizing and approving its inclusion in the page.

### BACKGROUND OF THE INVENTION

Internet advertising/marketing began in the early 1990s as simple, text-based web sites that offered product information. Over time, the Internet marketing evolved into more than just selling information products: people started selling advertising space, software programs, business models, and many other products and services. Some of the benefits associated with Internet marketing include the availability of information. Consumers can surf over the Internet and learn about products, as well as purchase them, at any hour. Companies that advertise over the Internet can also save money because of a reduced need for a sales force. Moreover, the advertising over the Internet can help expand from local markets to both national and international markets. Unlike the “offline” marketing media, such as newspapers, radio and TV, entry into the realm of the Internet marketing can be much less expensive.

Furthermore, the Internet users' response and overall efficiency of the Internet advertising is much easier to track than that of the “offline” media, since Internet marketing offers a greater sense of accountability for advertisers. Compared to the other media marketing (e.g., newspapers, radio and TV), Internet marketing is rapidly growing, gaining popularity among small businesses and consumers that try to monetize their web site or blog.

Currently, users that wish to advertise their products and services over the Internet usually contact corresponding owners (or publishers) of web sites, or advertising agents who purchased the advertising areas and offer them for advertisements. Typically, the user sends to a web site owner or agent a banner, image or a text link which relates to the advertised subject, and pays for placing the advertisement for a predefined period of time. After receiving the payment, the web site owner or the agent through the web site owner places the advertisement on his web site. However, the period of time from the moment the advertiser has sent a request to place his advertisement until the moment said advertisement is actually placed on said web site, is relatively long due to several reasons. For example, one reason for the delay is the need for the site publisher to process the request for advertising. Another reason that typically accounts for a delay is when an advertising agent receives the advertisement, processes it, and forwards it to the site publisher, for placement in one or more of the site pages.

Another problem which is typically associated with this procedure is that the user submits his advertisement, but he does not know exactly where in page the advertisement is placed, and even then, what specific content is associated with it (for example, in a news site there the content of the pages are changed very frequently), and how the advertisement looks with respect to other advertisements that are currently exist in the site.

Several web sites, such as http://www.planetmoms.com, http://www.mommyshelperonline.com, http://www.shanghaiist.com, http://www.writesight.com, etc. offer self-service advertising over the Internet. A user surfing to a self service advertising site, uploads his corresponding advertisement banner (or sends the banner to a web site owner by an email), makes an online payment, and then his advertisement is placed on a selected page of a web site. Generally, there is no direct connection between the user and a specific web page. The user submits his advertisement, and the self service agent introduces the advertisement to one or more sites later on. The advertiser is sometimes provided with an example of a web page (for example, as a *.jpg document), and a skeleton showing where the advertisement is intended to be placed. However, the advertiser cannot view in real time his advertisement location and placement in the page, before approving the advertising campaign.

JP 2002109357 proposes a method for the self-served advertising over the Internet. According to JP 2002109357, after an advertiser clicks on a banner/image displayed within the web page, he is invited to place an advertisement within the frame comprising said banner. Then, the advertiser selects a period of time for which he would like to advertise his product/service (e.g., one hour, one day, one week, etc.), and uploads to the web site his corresponding banner/image (related to said product/service) to be displayed to users that surf to said web site. The advertiser makes a payment for his advertisement placement, and after that, his advertisement is displayed within the web site.

Neither the above prior art web sites nor JP 2002109357 allows advertisers to switch a normal (conventional) web site presentation to an advertising web site presentation, in which the advertiser can directly select a specific location within the web page for placing his advertisement, and then to place the advertisement in an immediate and convenient manner, while noticing simulation of the advertisement placement within the real page (in contrast to a sample of the page). In addition, none of the prior art publications allows a web site owner (publisher) access the web site in a conventional manner, to switch from a normal (conventional) site presentation to a publisher site presentation, which allows the site publisher to conveniently define settings of each of his various advertising spaces such as advertising costs, changing advertisements dimensions, etc., and to view advertising statistics.

It is still another object of the present invention to provide a method and system for self introduction of an advertisement by an advertiser directly to a selected page of a web site.

It is still another object of the present invention to provide immediate display of the web page including the advertisement to the advertiser before approval.

It is still another object of the present invention to provide such a self advertising method, which is much user friendly that conventional ones.

Other objects and advantages of the invention will become apparent as the description proceeds.

### SUMMARY OF THE INVENTION

The present invention relates to self service advertising method, which comprises: (a) displaying a web page in a normal mode, wherein the page comprises content and active advertisements that are displayed in specific advertising spaces within the web page; (b) providing the same web page in an advertiser mode, wherein the page is displayed with the same content and content placement as in said normal mode, while those advertising spaces that are offered for future advertising are shown without their active advertisements and in their exact same placement in the document as in said normal mode, and wherein each advertising space comprises at least a link for guiding an advertiser to a process for self placing an advertisement within said advertising space; and (c) a predefined virtual button or link within said web page in both said normal and advertiser modes for effecting switching between said normal and advertiser modes.

A “same placement”, in the context of this invention, means a same size and location of a corresponding object within the page.

Preferably, the method further comprises the providing of the same web page in a publisher mode, wherein the page, including its content, is displayed in the same placement as in said normal mode, while each advertising space within the web page which is offered for advertising comprises a link which guides a publisher to a procedure for defining settings for said advertisement space or for viewing existing settings and statistics relating to the activity of an advertisement which has already been placed by an advertiser within said space, and wherein entrance into the publisher mode is performed by means of a virtual button or link within said web page in the normal or advertiser mode, and wherein a restricted entrance into said publisher mode is allowed only to said publisher by means of a password.

In an embodiment of the invention the method further comprises a procedure for placing an advertisement by an advertiser within a selected advertising space in said advertiser mode, said procedure comprises one or more of the following: (a) uploading by an advertiser a corresponding advertisement into a selected advertising space; (b) selecting a schedule for publishing said advertisement; and (c) paying for publishing said advertisement within said advertising space during said schedule.

In an embodiment of the invention the method further comprises displaying to the advertiser in said advertising mode within each advertising space statistics which relates respectively to past activity of advertisements placed in said advertisement place.

In an embodiment of the invention the method further comprises displaying in the advertiser mode within each advertising space the costs for advertising within said advertising space.

In an embodiment of the invention the method further comprises offering to an advertiser within an advertisement space in the advertiser mode to submit a bid for placing his advertisement within said advertising space.

In an embodiment of the invention, the settings and definitions of advertising spaces that are introduced by the publisher in the publisher mode are exported and embedded within the corresponding web page.

Preferably, the method of the invention further comprises the same web page in a simulation mode, wherein after the step uploading by the advertiser of the advertisement into a selected advertising space, the same page is displayed to the advertiser in said simulation mode with the same content, content placement, advertisements and advertisement placement as in said normal mode, while the newly uploaded advertisement substitutes a corresponding advertisement that exists in the same space in the normal mode, to enable the advertiser to evaluate his new advertisement placement in relation to the other content and advertisement objects within the page.

In an embodiment of the invention, the method further comprises the defining of one or more of the following: (a) one or more keywords forming a condition for the display of the advertisement within a web page which contains said keywords; (b) one or more topics of a web page, forming a condition for the display of the advertisement within a web page whose topics meet said defined topics; (c) one or more time periods in which said advertisement is displayed.

In an embodiment of the invention, the physical setting definitions for each advertisement space are selected from the following: (a) advertisement space unique name; (b) object type; (c) location within the page; (d) advertisement space dimensions; (e) time sharing of advertisements within the advertisement space; and (f) advertising schedule.

In an embodiment of the invention, the logical setting definitions for each advertisement space are selected from the following: (a) advertiser profile; necessity to receive publisher approval; and (b) content of the space when being unoccupied by an advertisement.

In an embodiment of the invention, the billing setting definitions for each advertisement space are selected from the following: (a) pricing method; and (b) billing system.

In an embodiment of the invention, the publisher is the site owner. In another embodiment, the publisher is an advertising agent.

In an embodiment of the invention, active advertisements within the normal mode appear pale in the in the advertiser mode in same corresponding advertisement spaces.

### BRIEF DESCRIPTION OF THE DRAWINGS

In the drawings:

FIG. 1 is a schematic illustration of a conventional web page presentation (normal mode), according to an embodiment of the present invention;

FIG. 2A is a schematic illustration of the page of FIG. 1 in an advertiser mode, according to an embodiment of the present invention;

FIG. 2B is a schematic illustration of the page of FIG. 1 in an advertiser mode, according to another embodiment of the present invention;

FIG. 3A is a schematic illustration of the web page of FIG. 1 in the publisher mode, according to an embodiment of the present invention;

FIG. 3B is a schematic illustration of the web page of FIG. 1 in the publisher mode, according to another embodiment of the present invention;

FIG. 3C is a schematic illustration of a page in the publisher mode, which is shown to the publisher after he clicks on a selected advertisement space within one of the pages of FIG. 3A or FIG. 3B, according to an embodiment of the present invention;

FIG. 4 generally illustrates a procedure which is performed by the publisher while defining advertisement spaces within a web page in the publisher mode according to an embodiment of the present invention:

FIG. 5 is a flow diagram which generally illustrates the procedure of operation in the advertiser mode and in the publisher mode, according to an embodiment of the present invention;

FIG. 6 illustrates in block diagram form the basic structure of the system of the present invention;

FIG. 7 illustrates in general the procedure which is performed by an advertiser while submitting an advertisement into an advertisement space, within the context of the advertiser mode; and

FIG. 8 is a flow diagram which generally illustrates the procedure which takes place at the publisher site after the submission of the advertisement by the advertiser

FIG. 9 is a block diagram of an exemplary digital computer (server or client machine).

FIG. 10A illustrates an exemplary technique for providing multi-mode web pages and for facilitating future advertising where an embedded script is sent to the client for effecting the mode transition.

FIG. 10B illustrates an exemplary technique for providing multi-mode web pages and for facilitating future advertising where a session variables are used by the content server for facilitating the mode transition.

FIGS. 11A-11B illustrate exemplary techniques for configuring the content server to respectively facilitate the technique of FIGS. 10A-10B.

### DETAILED DESCRIPTION OF THE PREFERRED EMBODIMENTS

Hereinafter, when the term “web page” is mentioned, it should be understood that it refers to any document(s) (e.g., textual document, image, picture, graphics, etc.) stored within a database (server) over the data network, such as the Internet, Ethernet, LAN (Local Area Network), cellular Internet, etc. Also, the term “document” further refers to a computer/television screen presentation, software application screen presentation, game screen presentation, wherein one or more advertisements are displayed. In addition, the present invention can be implemented within any online software application, any online computer/television game, any web site provided over the data network and the like, enabling a user (advertiser) to change a visual presentation of what is displayed on a computer/television screen for placing his one or more advertisements, and/or enabling a web site owner/software provider to have an access and change (upon the need) settings of all advertisements to be placed within his web site/software.

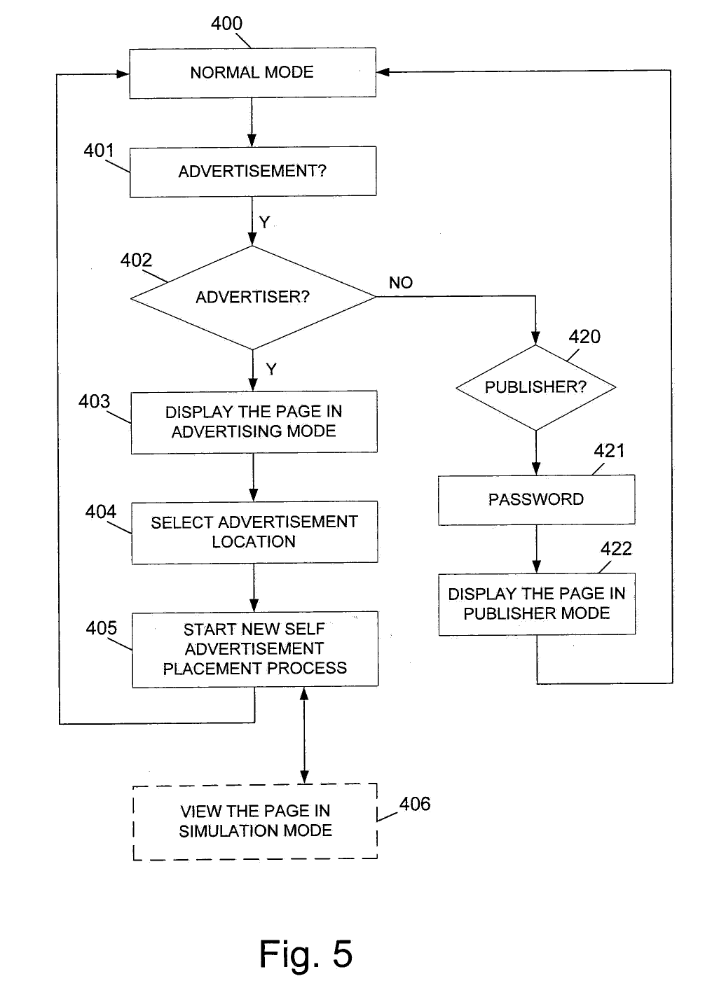

FIG. 5 is a flow diagram which illustrates in general form the self service advertising process according to an embodiment of the present invention. According to the present invention, a same web page is selectively displayed in plurality of visual modes, as follows:
a. Normal mode in which the page is displayed as is conventional, i.e., with its content and advertisements that have already been introduced into it;
b. Advertiser mode in which the same page is displayed in a manner which shows the same exact page, including its content as in the normal mode, however, with the advertisements spaces being empty from advertisements, but indicated as frames for the introduction of advertisements into them. The page in the advertiser mode therefore enables an advertiser to select an advertisement location (one of the frames) within the page, to introduce an advertisement into one of said frames, and to perform all the necessary procedure in order to complete the advertisement placement, including selection of the advertisement schedule, period, payment, etc. Optionally, the advertiser mode also comprises within it a simulation mode in which the advertiser views the same page with its exact content as presently displayed to the users in the normal mode, together with his advertisement and other advertisements that are presently included in the page.;
c. Publisher mode in which the same page is displayed in a manner which enables the publisher to view the page exactly as it is presently displayed to surfers, however, within each advertisement space the publisher (the advertising agent, the site owner, etc.) can view important information relating to that specific advertisement. Alternatively, the publisher can press on said advertisement frame in order to enter into another page which corresponds to said selected advertisement space in which information (for example, statistics relating to that advertisement space) is displayed to him. Furthermore, in additional to said information, the publisher can define in that page all various definitions that correspond to that page.

Referring back to FIG. 5, in step 400 the user views the page in normal mode, which is a conventional presentation of the page. If the user wishes to enter into the self advertising process of the invention (step 401), he enters into an advertiser mode (step 402). In such a case, he may remain in the advertiser mode in order to self introduce a new advertisement, or he may go to the publisher mode (entrance into this mode requires the introduction of a publisher password). If the user is an advertiser, he stays in the advertiser mode, and the page which is displayed to him is displayed in advertiser mode presentation (step 403). In this mode the page is displayed to him exactly with the same content and format as in the normal mode, however, with empty advertisement frames (the frames are “empty” of advertisements, but may include some text) that are located in their exact location and have a same size as they have in the normal mode presentation of the same page. The advertiser can now select (step 404) one of the frames, and perform a full self advertising procedure (step 405), by introducing therein his advertisement, selecting a schedule for publishing it, and carrying out payment using a self service interface. Optionally, after introducing his advertisement, the advertiser may also enter into a simulation mode (step 406), in which the page is shown to him exactly as in the normal mode (i.e., including the present advertisements that are already included there), however, with the newly introduced advertisement at its exact location and place, as introduced. In such a manner, the advertiser can see the page exactly as it will be displayed later on to users. The advertiser can now verify whether he likes the advertisement as simulated (in itself and in relation to all other advertisements in the page), and if not, he may return to the advertiser mode, make changes, and return to the simulation mode. This procedure may be repeated as is necessary, until the advertiser is satisfied with the advertisement as placed. Then, the advertiser can return to the advertiser mode to complete the payment. Upon completion of payment, the advertiser may return to the normal mode page (step 400). It should be noted that upon entry into the advertiser mode, the advertiser may surf throughout various pages of the site, while all the pages are displayed to him in the advertiser presentation.

If, however, in step 402 the user is not an advertiser, but alternatively is the publisher, i.e., the one who sells the advertisement of the page (step 420), he enters into a publisher mode. In order to enter into the publisher mode, the publisher has to introduce his password (step 421), and this is generally performed in a protected mode. Upon entry into the publisher mode (step 422), the page is introduced to him in a publisher visual presentation, and a publisher interface is activated. Now the publisher can obtain information about any advertisement which is included in the page, for example, on the number of entries to the advertiser site that are performed through each advertisement, and even the amount of money collected through each advertisement. Alternatively, in the publisher mode the publisher can provide definitions for each of the advertisement spaces, for example, the price for each space, the schedule and periods of appearance proposed for each space, the location and size within the page of each space, etc. The term “space” where used herein, refers either to a two dimensional location within a web page which is suitable for including of a banner of any conventional type (e.g., image, JavaScript program, or multimedia object), or to a location which is suitable for including a text link which guides the user into the advertiser site. The manner of operation of the publisher mode will be explained in more details hereinafter.

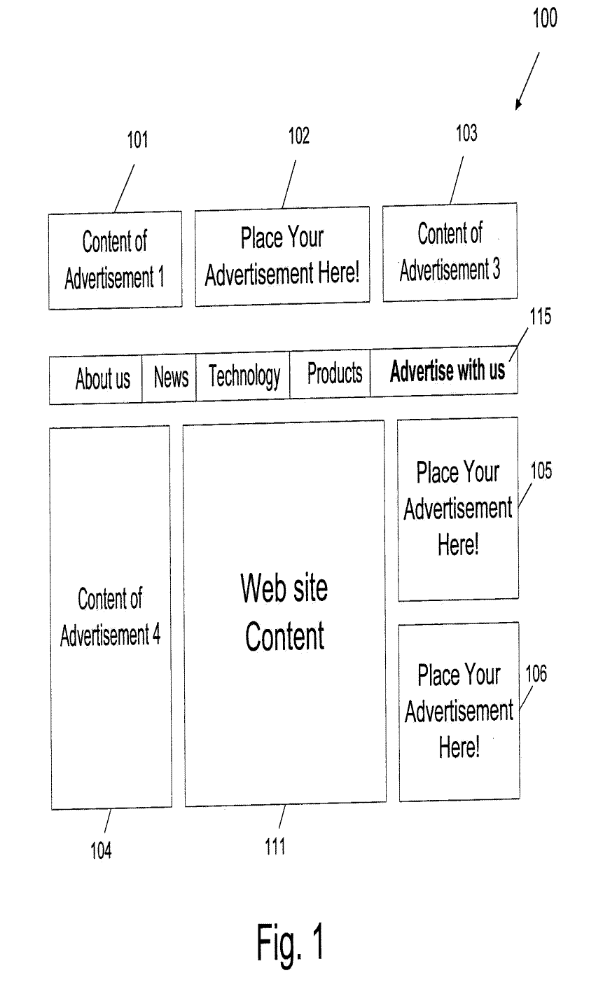

FIG. 1 is a schematic illustration of a web page 100 presentation in the normal mode, according to an embodiment of the present invention, web page 100 comprises content 111, and plurality of advertising spaces, such as advertising spaces 101, 102, 103, 104, 105 and 106, in which advertisements can be placed. By clicking on a specific advertisement (such as advertisements 101, 103, or 104), the web site user is automatically redirected to the advertiser site, or alternatively to another advertising page which may be located within the publisher site. If no advertisement is placed within the advertising space (such as advertising space 102, 105 and 106), then the user is presented with an invitation to advertise within this web site (for example, by means of a message “Place your advertisement here!” or the like). By clicking on one of the spaces 102, 105, 106, or 115, the user enters into the advertising mode.

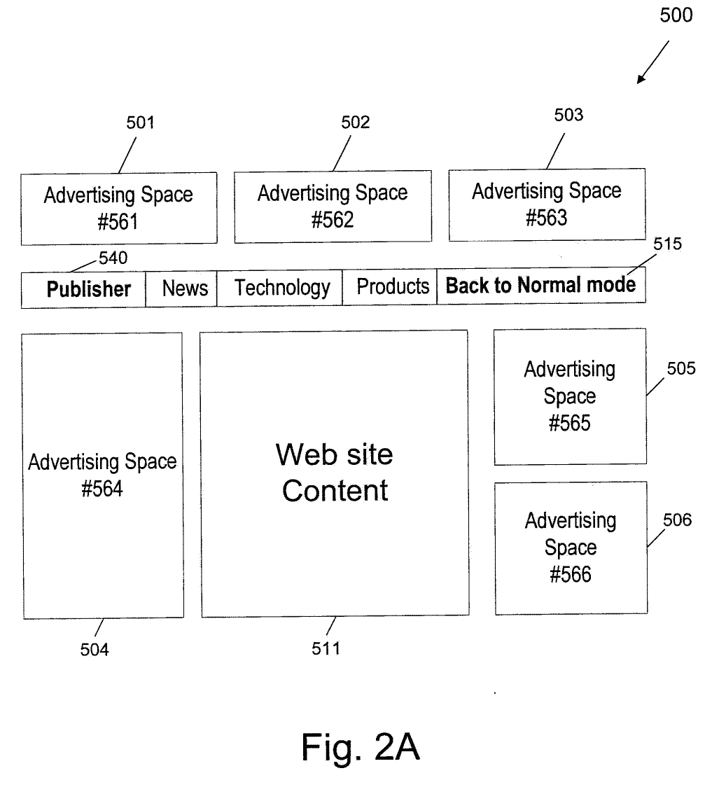

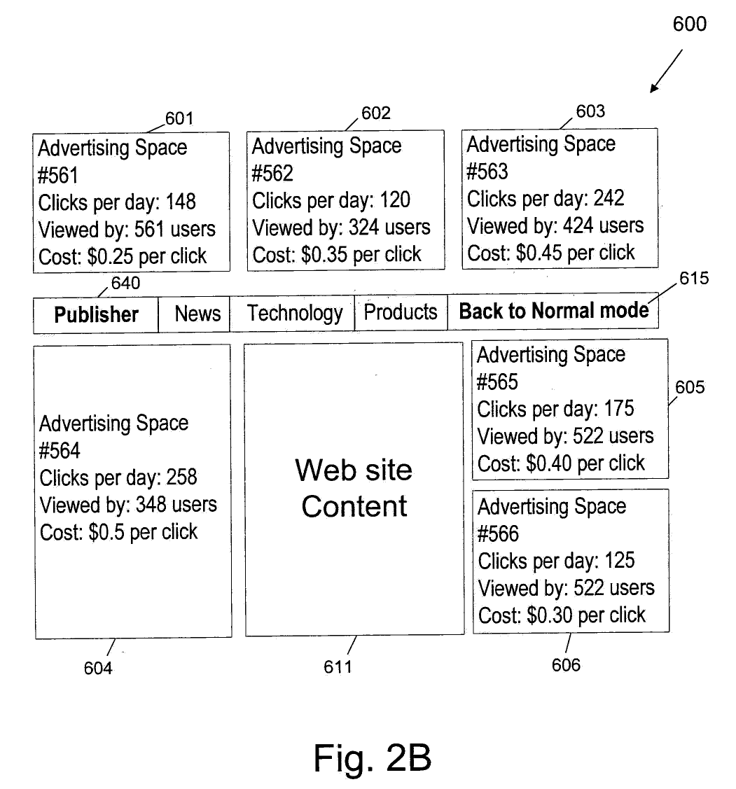

FIG. 2A is a schematic illustration of a web page 500 in the advertiser mode, as appears to the user who clicks on one of the empty spaces 102, 105, or 106 of web page 100 (in normal mode) of FIG. 1, according to an embodiment of the present invention. In the advertising mode, the web page 500 is displayed to the user exactly the same as web page 100 in the normal mode, with the same content and placement of the offered advertisement spaces of page 100. The advertisement spaces appear in their exact same size and location as they are offered for advertisement. However, in contrast to the normal mode where advertisements appear in the page, the advertisements spaces within page 500 do not appear, but alternatively, a reference number for each of said advertising spaces appears. Alternatively, the advertisements may appear in a pale color to indicate that they are irrelevant in this mode, but are only provided for illustration. The user selects a specific advertising space within which he wishes to place his advertisement (such as advertising space 501, 502, 503, 504, 505 and 506), and clicks on it. Then, he is redirected to a self service interface (not shown, but is conventional in self service advertising) for placing his advertisement in the same selected location.

The self service advertisement interface is a tool which enables the advertiser to place his advertisement within the selected space. Among others, the interface displays to the user the possible schedule in which the advertisement can appear within the page, for example, from April 1 to April 10, every day from 9.00 AM to 10 PM, or each Monday from 12.00 PM to 13.00 PM; etc. Furthermore, the advertising price and all other essential information required by the advertiser to place the advertisement are also provided. Using the self service tool the advertiser uploads his advertisement (text, image, video, sound clip, or any other conventional advertisement), and pays the required amount. After completing the payment, the advertisement is essentially immediately displayed within the selected advertising space (if such an immediate selection was made), or alternatively at any other schedule selected by the advertiser.

In one embodiment, the advertiser may arrange an account with the publisher, and then, he may log-in at any desired time to his personal advertiser mode (by entering a password), and add a new advertisement, remove an existing advertisement, change settings and characteristics of his advertisement (such as the schedule, the content, the colors, background, etc.).

As long as the advertiser stays in the advertiser mode, he has the option of surfing within other pages of the same site, and placing additional advertisements in other available advertisement spaces of other pages. In a similar to what has been described, also the other pages are displayed to the advertiser in the same manner as page 500 of FIG. 2A.

The reference numbers of the advertising spaces are given only as an example. According to another embodiment, when the advertising space is available for an immediate advertising, for example, advertising space 501, a phrase such as “Available For Immediate Advertising” may be displayed.

It should be noted that there is no minimal advertising period, which may be even several minutes. There is also no maximal limitation period.

FIG. 2B is another example, similar to page 500, for a web page 600 in the advertiser mode. The advertiser is provided with various statistical data relating to each advertising space. For example, the advertiser is provided with an indication relating to the number of users who have clicked within a predefined period of time (e.g., clicks per day, per week, etc.) on each advertising space, and with an indication relating to the total number of users who have clicked on each space, with the cost per advertisement click (or another payment form), etc. If the space is not available for an immediate advertising, an indication as to the time of availability (i.e., the expiry time) may be presented. On the other hand, if the advertiser has already established an account with the publisher, and he has already published within this specific web page, he is provided with statistical data with respect to the advertisements he has already introduced within the page. Such statistical data may be presented to the advertisers directly on advertising spaces 601 to 106 respectively, or it may be presented to him only after he clicks on a specific advertising space. The web site publisher defines what statistical data is presented to the advertiser for each advertising space, for example: daily, weekly, or total number of clicks, statistics regarding the geographical location of web site users who have clicked on each advertising space, statistics regarding day or night periods clicks, or distribution thereof.

As said above, the advertising price may also be displayed within each advertising space. The price may be divided according to the advertising time criteria. For example, the price per click between 9.00 AM and 7.00 PM may cost $0.5, and between 7.00 PM and 9.00 AM may cost $0.05 per click.

In any case, at the end of the advertisement placement procedure, the advertiser pays for all the advertisements he has placed, and leaves the advertiser mode. The advertiser may leave the advertiser mode, for example, by clicking on spaces 515 or 615 of FIGS. 2A and 2B respectively.

According to still another embodiment of the present invention, the advertiser after selecting an advertising space (such as advertising spaces 501 or 506) may additionally select introduction of his advertisement on specific types of web pages, for example, pages with news contents, archived pages, sport pages, and so on. Then, he will be presented accordingly with the respective cost. Alternatively, the advertiser may define keywords for pages in which his advertisement will appear. In that case, the advertisement will appear in these types of pages in the format as selected in the advertiser mode, without selecting the specifically pages. For example, the advertiser may request that his advertisement will appear within web pages that contain with the keywords “cellular phone” and/or “wireless communication”. In another example, the advertiser may request that his advertisement will appear on pages with specific keywords in the selected place only when said web page is archived.

According to another embodiment, if one or more advertisers are interested in placing their advertisement within a same advertising space for the specific future time, then the advertiser sets an Internet auction. The advertisement, for which the largest bid was submitted, is displayed within said advertising space during said time period.

According to still another embodiment of the present invention, the advertiser may define that his advertisement will be displayed only to users within a particular geographic location, which is determined according to the user IP address. Further, the advertiser may specify to which users his advertisement will be displayed. For example, he may select that his advertisement will be displayed only to new web site users (the user is determined as new, if no cookie of said the specific web site is stored within his computer. If the web site user is a registered user, and he has submitted his personal information during the registration, then such information is used by advertisers for providing targeted advertisements. For example, the advertiser may define that his advertisement will be displayed to a specific gender only, to users of ages 21 to 35, etc.

FIGS. 2A and 2B illustrate the manner of operation of the advertiser mode. If, however, the user is the publisher of the site (as said, the publisher for this purpose is the advertisement owner, i.e., the site owner or the advertising agent), he can enter into the publisher mode by clicking on the “Publisher” space 540 or 640 of FIG. 2A or 2B respectively. Alternatively, the entrance to the publisher mode may be performed through a hidden link at the advertiser mode page, or by means of providing the appropriate URL at the browser. Then, the publisher has to provide his password in order to enter into the publisher mode.

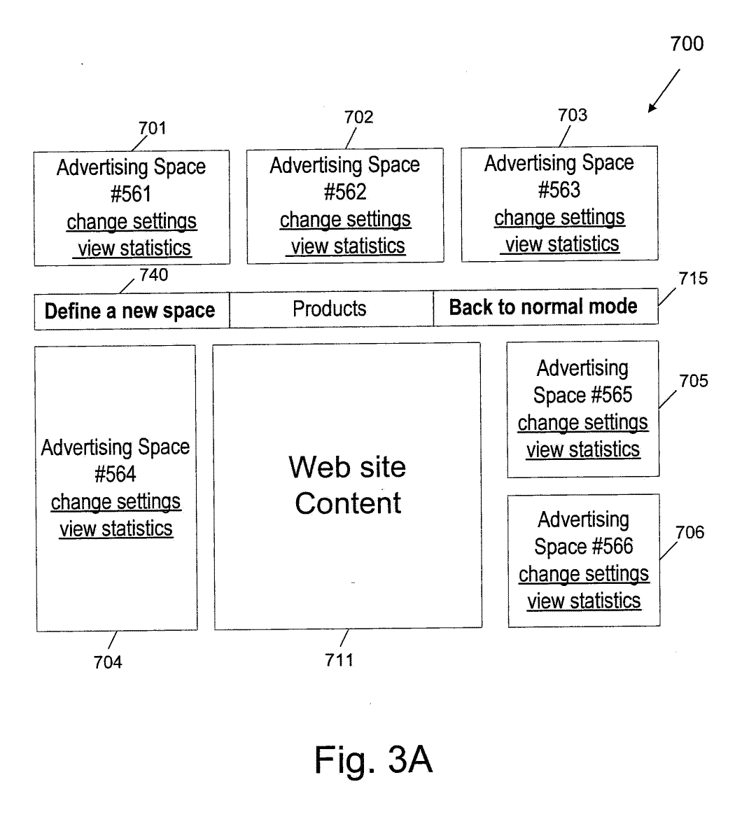

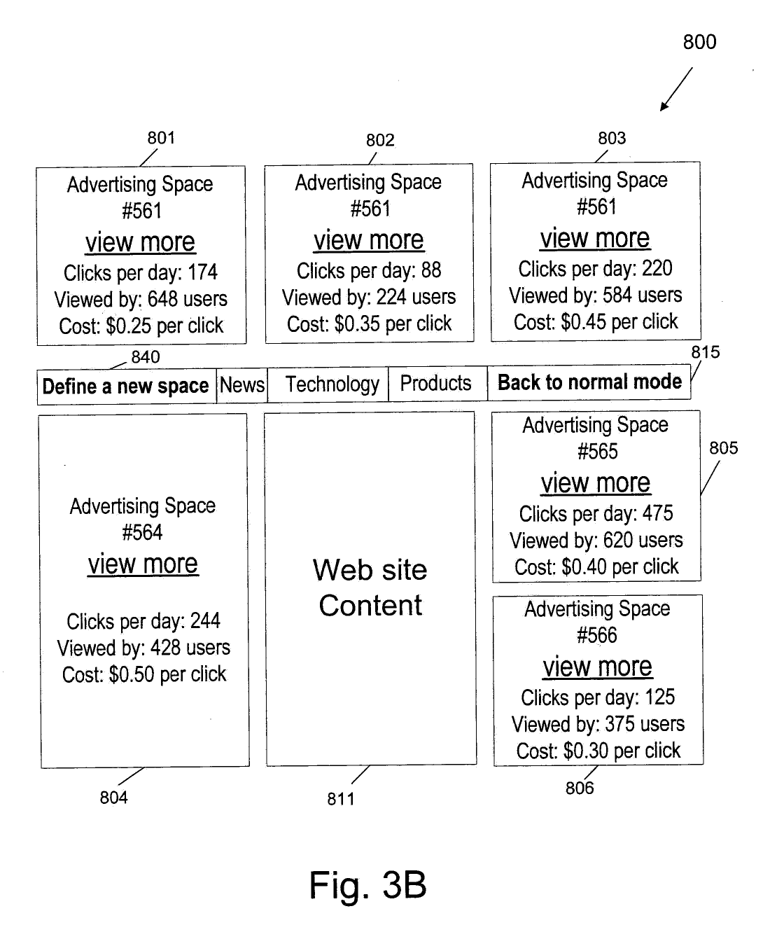

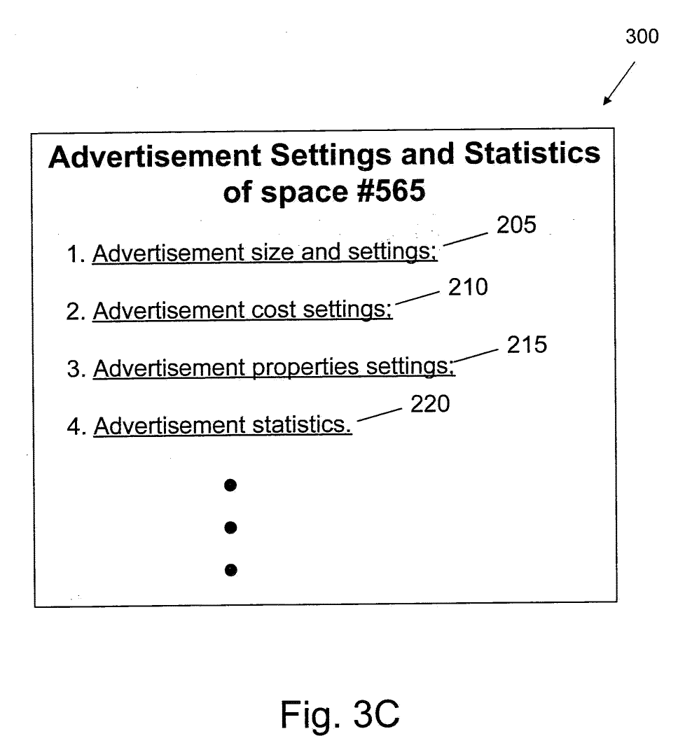

FIG. 3A illustrates a web page 700, which corresponds to the page 100 of FIG. 1, as presented to a user in the publisher mode, according to an embodiment of the present invention. In similarity to the advertiser mode of FIGS. 2A and 2B, page 700 of the publisher mode displays the content and advertisement placements exactly as they appear in the normal mode page of FIG. 1. Each advertisement frame is displayed to the user optionally with its reference number. In the publisher mode, the publisher can essentially provide settings and definitions to each of the advertising spaces 701 to 706, and also to view statistics with respect to each active advertising space. For example, by clicking on the specific links of advertising space 705, the user enters into a publisher interface program which enables the publisher to either define all settings which relate to this space, or to view statistics with respect to the activity of this space, respectively. For example, if the user clicks on “change settings” within space 705, the interface enables him to define the dimensions and location of space #765, its advertising costs, schedule definitions, and various other properties such as this specific space background color, etc. In addition, by clicking on “view statistics” within advertising space 705, the publisher may view advertising statistics that relate to this specific space. For example, the publisher may view how many users have clicked on this specific advertisement within some time period (for example between Monday to Wednesday), how much money he earned from this specific advertisement on Tuesday, and the like. Also, the publisher may print reports of such statistics and provide reports to advertisers upon their request. Furthermore, in still another embodiment the publisher may be informed by email or SMS (Short Message Service) about the activities of advertisers of his web site.

FIG. 3B shows another alternative embodiment to the publisher mode presentation of FIG. 3A. In this embodiment, some statistics and information are already provided within each of the spaces 801-806. If the user wishes either to provide settings or to receive more statistics, he can click on “view more”. For example, upon clicking on “view more” of space 805, the page of FIG. 3C is displayed to him. Then, the user may either select to define size and location settings of this specific space #565 by pressing on option 205, he may select to define the cost settings of this advertisement space by clicking on option 210, he may select to define properties of #565 (option 215), or he may select to view statistics of #565 (option 220).

In case that the page does not yet contain any definition for an advertisement frame, or when the publisher wishes to add a new advertisement frame, the publisher may click on space 715 or 815 within the pages of FIGS. 3A and 3B respectively, in order to add a new definition for an advertisement frame. Then, the publisher may enter into the publisher interface for creating and defining a new advertisement frame.

As mentioned, upon entry into the publisher mode, the publisher views the pages of FIG. 3A or 3B. Within each advertisement frame, the advertisement may be shown to the publisher at the background in a pale form. The publisher may select to surf during the publisher mode between the various pages of the site, and for each page he may view the corresponding page in a manner similar to FIG. 3A or FIG. 3B.

According to still another embodiment of the present invention, more than one advertisement is displayed within an advertising space (for example, advertising space 104 of FIG. 1). For enabling this option, the publisher may embed, for example, a special software code into his web site. For example, he may embed into the web site the code provided by Google™ AdSense™ program, enabling the Google™ company to place advertisements of its advertisers within said web site. The advertiser who wishes to also advertise within the same web site may enter into the advertising mode (FIGS. 2A and 2B) in a manner as described. Then, in the advertising mode page of FIG. 2A or of FIG. 2B, and after clicking on an advertisement provided by said Google™ AdSense™ program, he may place his advertisements instead of, or in addition to said advertisement on which he has clicked. In such a case, the space will alternately change between the advertisement of Google and the advertisement that has been now introduced in the advertising mode.

Alternatively, the advertiser may place a bid for paying a higher tariff than the payment by the advertiser of the advertisement on which he has just clicked, and then his advertisement will replace said advertisement.

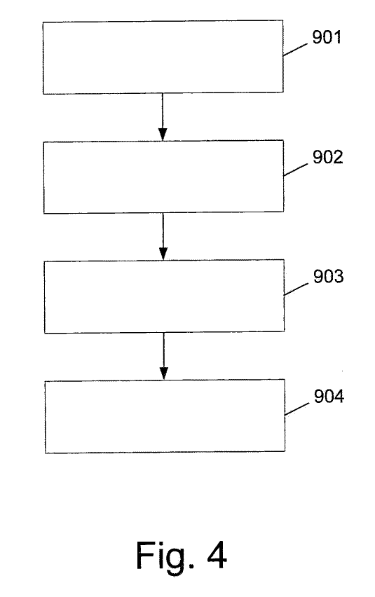

FIG. 4 illustrates the general procedure which is performed by the publisher while defining all the advertisement spaces. In step 901 the publisher logs on into the publisher mode (generally from the advertiser mode); in step 902 the publisher defines or updates definitions for the various advertisement spaces; In step 903 the publisher submits his definitions; and in step 904 the publisher definitions are exported in a form of a software code and are embedded within the web site pages. It should be noted again herein the publisher updates of FIG. 4 may be performed by a publisher which is the site owner himself, and who owns one site, or it may be performed by a publisher who sells advertising spaces in plurality, generally many web sites that are owned by different site owners, and in that case, the publisher introduces the updates through a central server. The definitions by the publisher generally relate to the following subjects:

### Physical Definitions:

a. Advertisement space unique name;
b. Possible object type: image, multimedia, text link, etc.;
c. Location: where in the page the space will be located:
d. Advertisement dimensions: in the case of a banner, the dimensions of the banner;
e. Time sharing: defines whether the space is shared between different advertisers, and if so, the manner of sharing;
f. Advertisement available times: the time in which the space is available for advertising.

### Logical Definitions

a. Advertiser profile: optionally limits the advertisement to specific types of advertisers, i.e.,—in specific business fields;
b. Requires publisher approval?: defines whether the advertisement requires approval of the publisher before actual publishing. In some cases the requirement for approval may be defined for new users only;
c. Unoccupied advertisement definition: defines the text or image that will appear within the space of the advertisement, at times when no advertisement appears.

### Billing Definitions

a. Pricing method: defines whether the advertisement will be priced by the number of click entries, by a global price, etc.;
b. Billing system: defines whether the advertiser pays directly to the publisher or to a centralized operator of the system.

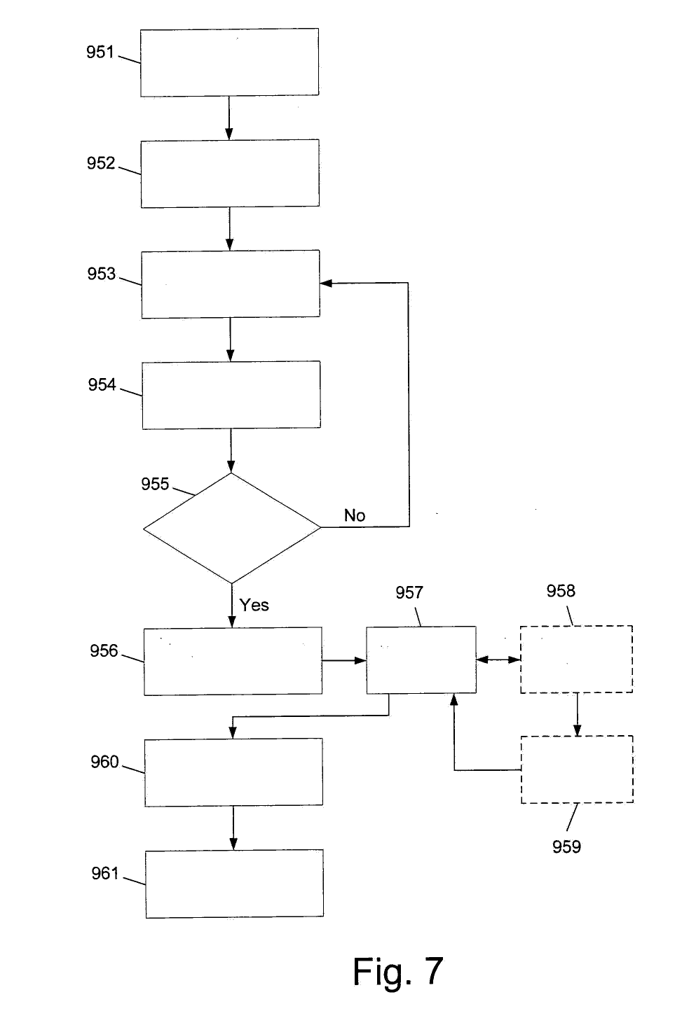

FIG. 7 illustrates the general procedure which is performed by the advertiser while submitting an advertisement into an advertisement space. In step 951 the advertiser enters into the web site, and views a page in its conventional, i.e. normal mode. Upon clicking on a space such as “advertise here” 115 of FIG. 1, the advertiser enters into the advertiser mode 952. As said, in the advertiser mode the advertiser views the same page in a form such as described with respect to FIG. 2A. In step 953, the advertiser clicks on a specific space, and enters into a self service procedure for submitting an advertisement into said selected space. In step 954, the advertiser views the conditions for that space, as defined by the publisher (see the description with respect to FIG. 4). In step 955, the advertiser may accept or not the conditions. If he does not accept, he returns to step 953, in which he has the option f selecting another space. If, however, he accepts the conditions of step 954, he continuous to step 956. In step 956 the advertiser logs on into his account, or establishes a new account. In step 957, the advertiser uploads his advertisement image, multimedia, or text link, etc. In step 958, the advertiser optionally activates the simulation mode, and views again the page as in the normal mode, however with the presently uploaded advertisement occupying the selected space. In such a manner, the user reviews his advertisement, and its relation to the page content and to the other advertisements within the page. In step the advertiser optionally amends his advertisement, and returns to step 957, in which he again uploads his advertisement. The optional simulation procedure may repeat several times, until the publisher is satisfied. In step 960, the advertiser fills an advertiser form, in which he adds his conditions and preferences for the advertisement. Finally, in step 961 the advertiser completes the payment and finalizes the advertisement submission.

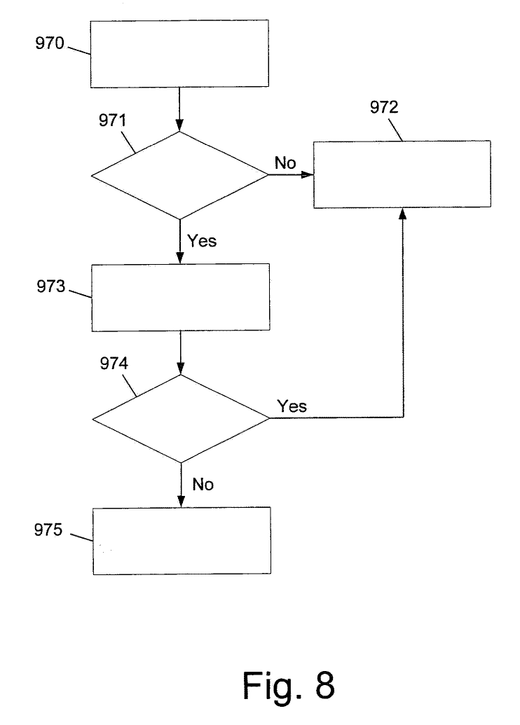

FIG. 8 is a flow diagram which generally illustrates the procedure which takes place at the publisher site after the submission of the advertisement by the advertiser. In step 970, the advertisement is received at the publisher site. In step 971 the conditions for advertising are checked. If the advertisement (or the advertiser) has defined by the publisher as not requiring approval, the advertisement is automatically introduced in step 972 into the page according to the appropriate schedule. If, however, it has been found in step 971 that the advertisement requires the publisher approval, it is further checked in step 973. If it is approved (step 974), the procedure continues to step 972 and the advertisement is published within the page according to the schedule. If, however, the publisher does not approve the advertising in step 974, the transaction is cancelled (step 975), and the advertisement is not published. A notice may be sent to the advertiser to acknowledge the same.

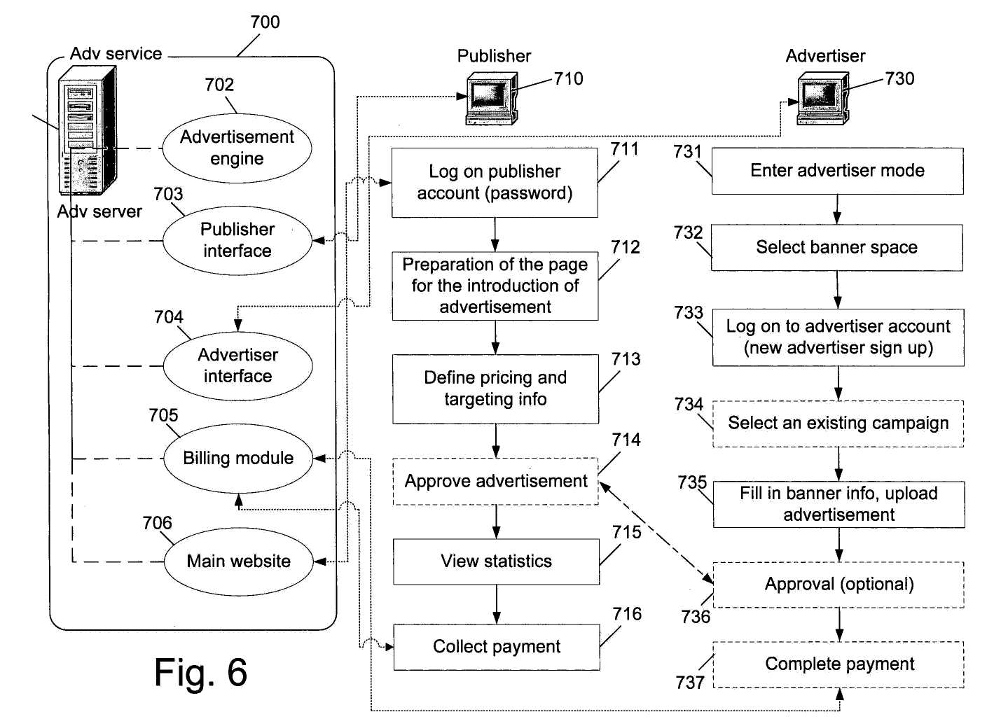

FIG. 6 describes in block diagram form the structure of the system for supporting the process of the invention, and also some aspects relating to the process of the invention. The system mainly comprises an advertising service sub-system 700, a publisher terminal 710, and an advertiser terminal 730. The advertising service sub-system 700 comprises an advertising server 701, which in turn comprises the following modules: advertising engine 702, for handling all the issues concerning the process of the invention, by coordinating the operation of all the other modules;
Publisher interface 703 which supports the publisher operation in the publisher mode;
Advertiser interface 704 which supports the advertiser operation in the advertiser mode:
Billing module 705 which handles all the financial issues relating to the self service advertising, including the billing of the advertiser, and the providing financial reports and statistics to the publisher; and
The main website, which comprises the contents that are associated with the various pages.

The advertiser terminal 730, mainly by means of the advertiser interface 704, generally performs the following operations:
Enabling the advertiser to view in a conventional manner the document within a site, and to enter into the advertiser mode (step 731) in which the same page including the content is displayed, however without the active advertisements (i.e., with the banner frames being empty from advertisements);

In step 732 the user selects an empty frame for placing his advertisement there;

In step 733 the advertiser enters his account details, of establishes a new account;
In step 734 the advertiser has the option of continuing an existing campaign he has;
In step 735 the user fills the banner information, including the advertisement schedule, and uploads his advertisement, which will be placed within the selected banner frame;
Optional step 736 enables approval to the advertisement by the publisher. This step will most probably be redundant at least when step 734 (continuing an existing campaign) is performed;
In step 737 the advertiser completes his payment, while working against the billing module 705.

The publisher terminal 710, mainly by means of the publisher interface 703, generally performs the following operations:
It enables the publisher to log on into his corresponding publisher mode, by entering his password. It should be noted within a same site, or even within a same page (document) there may be plurality of publishers, each having his corresponding banner spaces. In that case, the publisher will view only information which relates to his spaces;
In step 712 the publisher performs preparation of the page for the introduction of advertisements;
In step 713 the publisher defines the pricing terms for each banner;
In optional step 714 the publisher approves a portion or all the newly introduced advertisements;
In step 715 the publisher receives information, such as statistics about the banners:
In step 716 the publisher collects the payment for the advertisements.

### Example

The owner of the site receives from the advertising management system a source code/s which he embeds with each desirable advertisement space. This embedding of the source code can be performed using various known technologies (JavaScript, HTML. Perl, asp, PHP, etc.,) that enable producing a linkage by means of a linkage file (ASP, PHP, XML, JavaScript etc.). Alternatively, the site owner may install the source code into local or distant Database (such as XML, Web Service, SQL, Oracle, etc.) which the desirable object which is displayed within the advertisement space on the web page has a http request or linkage or variable or pointer to this source code.

The source code (linkage) may include three main parts:
1. Source—which indicates the content of the object: banner, text or any other advertisement type which the advertiser select to place within the advertisement space (for example, an image, video, a flash object, or a textual presentation),
2. URL Target includes a destination link for arriving to the object directly or indirectly (such as a URL address or function in a language like JavaScript etc.).

The embedded source code in advertisement space receives the link from the database and displays the desirable object within the web page.
3. Unique ID—identifies the address space.

When the surfer carries out a MODE change by clicking on a link that transfers him to one of the requested modes publisher mode, advertiser mode, etc., the selected mode is saved by means of one of the following:
1. In the advertisement managing server with parameters for identifying the surfer, such as IP and browser session ID and a parameter for identifying the site in which the surfer is located (Main URL).
2. In the site system itself in one of the following options:
   a. Usage of server side language (PHP, ASP or any other server side language for variables saving in the Database or a file containing data (like txt, CSV, XML, etc.).
   b. Cookie

By means of the following parameters the advertising system knows how to place the right contents within the advertisement space (Source and Target URL):
1. Surfer identification (Session ID, IP);
2. Space identification (unique ID);
3. Mode identification;
4. Main URL (an optional parameter which the system can find using a unique ID).
It is appreciated that in different embodiments, apparatus residing on the client side and/or on the service side may be operative to perform any of method disclosed herein (for example, by executing computing readable code).
   Discussion about a Computer

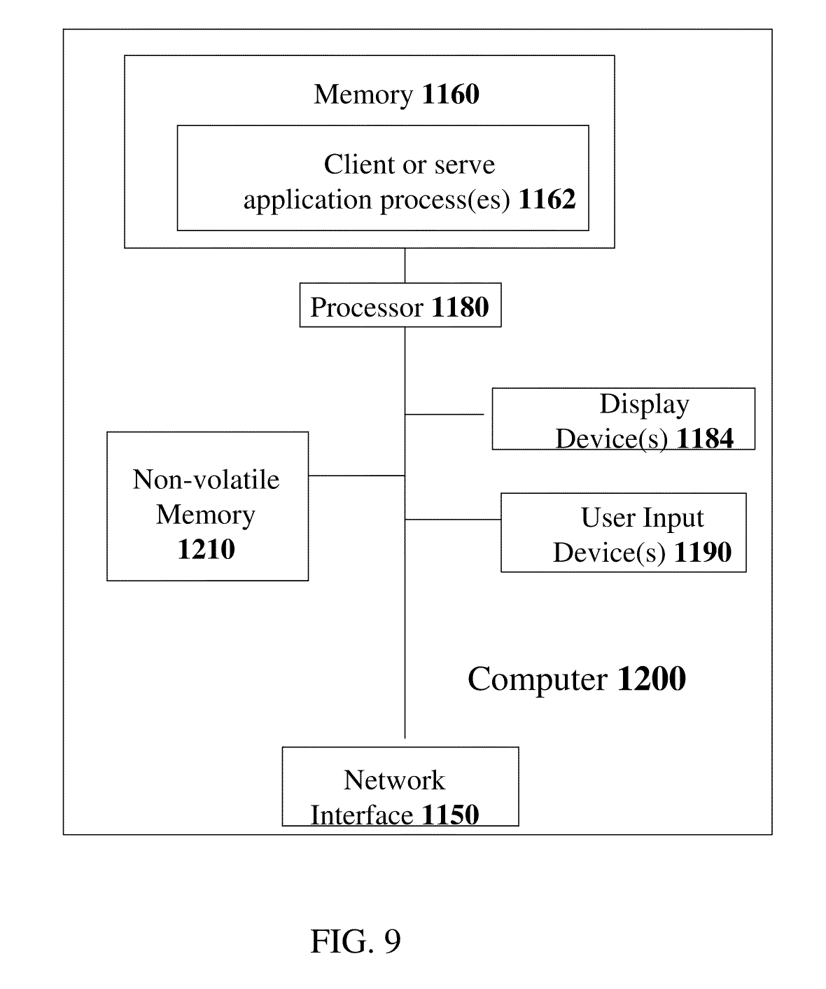

FIG. 9 illustrates one embodiment of a digital computer 1200 including a processor 1120. Processor 1180 is shown coupled to a memory 1160, a non-volatile storage 1210 (for example, a flash memory or a hard disk), a video display device 1184, one or more user input device(s) 1190, and a network interface 1150 such as a network interface card. It is appreciated that not every element is required in every embodiment.

Processor 1180 may be configured to execute instructions and to process data according to a particular instruction set architecture (ISA). In one embodiment, processor 1180 may be configured to implement an x86 compatible ISA, although in other embodiments it is contemplated that any desired ISA may be employed, such as the SPARC V9 ISA, PowerPC compatible ISAs, or MIPS compatible ISAs, for example. (SPARC is a registered trademark of Sun Microsystems, Inc.; PowerPC is a registered trademark of International Business Machines Corporation; MIPS is a registered trademark of MIPS Computer Systems, Inc.).

In various embodiments, memory 1160 may comprise any suitable type of system memory as described above, such as FB-DIMM, DDR/DDR2 SDRAM, or RDRAM, for example or any other types of volatile memory. Memory 1160 may include multiple discrete banks of memory. Also, in some embodiments memory 1160 may include multiple different types of memory.

In some embodiments, computer 1200 may include more than one instance of the devices shown, such as more than one processor 1180, for example. In various embodiments, computer 1200 may be configured as a rack-mountable server system, a standalone system, or in any other suitable form factor. In different embodiments, computer 1200 may be configured as a client system or as a server system.

In one embodiment, processor 1180 may be configured to run operating system software such as Microsoft Windows, IBM AIX or Sun Microsystems Solaris. Operating system software may in turn provide an environment in which processor 1180 may execute additional software modules in the form of applications, programs, or processes designed to perform specific functions. Running operating system software or software modules may comprise executing instructions that are stored in memory 1160. As shown in FIG. 9, a client or server application process 1162 resides in the memory 1160.

Software modules that may be executed by processor 1180 may include, in one embodiment, client/server software such as a web server or a web browser. Alternatively, or in addition, processor 1180 may execute software modules comprising network management software, office productivity tools, e-mail programs, etc.

In a networked deployment, the computer system may operate in the capacity of a server or as a client user computer in a server-client user network environment, or as a peer computer system in a peer-to-peer (or distributed) network environment. The computer system can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system can be implemented using electronic devices that provide voice, video or data communication. Further, while a single computer system is illustrated, the term “system” shall also be taken to include any collection of systems or sub-systems that individually or jointly execute a set, or multiple sets, of instructions to perform one or more computer functions.

As shown, the computer system may further include and/or be operatively linked to a display device 1184, such as a liquid crystal display (LCD), an organic light emitting diode (OLED), a flat panel display, a solid state display, a cathode ray tube (CRT), a projector, a printer or other now known or later developed display device for outputting determined information. The display may act as an interface for the user to see the functioning of the processor, or specifically as an interface with the software stored in the memory or in the drive unit

The present disclosure contemplates a computer-readable medium that includes instructions or receives and executes instructions responsive to a propagated signal, so that a device connected to a network can communicate voice, video, audio, images or any other data over the network. Further, the instructions may be transmitted or received over the network via a communication port. The communication port may be a part of the processor or may be a separate component. The communication 418 may be created in software or may be a physical connection in hardware. The communication port is configured to connect with a network, external media, the display, or any other components in system, or combinations thereof. The connection with the network (for example, see network interface 1150) may be a physical connection, such as a wired Ethernet connection or may be established wirelessly as discussed below. Likewise, the additional connections with other components of the system may be physical connections or may be established wirelessly.

The network may include wired networks, wireless networks, or combinations thereof. The wireless network may be a cellular telephone network, an 802.11, 802.16, 802.20, or WiMax network. Further, the network may be a public network, such as the Internet, a private network, such as an intranet, or combinations thereof, and may utilize a variety of networking protocols now available or later developed including, but not limited to TCP/IP based networking protocols.

### A Discussion of a Client Computer Provided by Some Embodiments

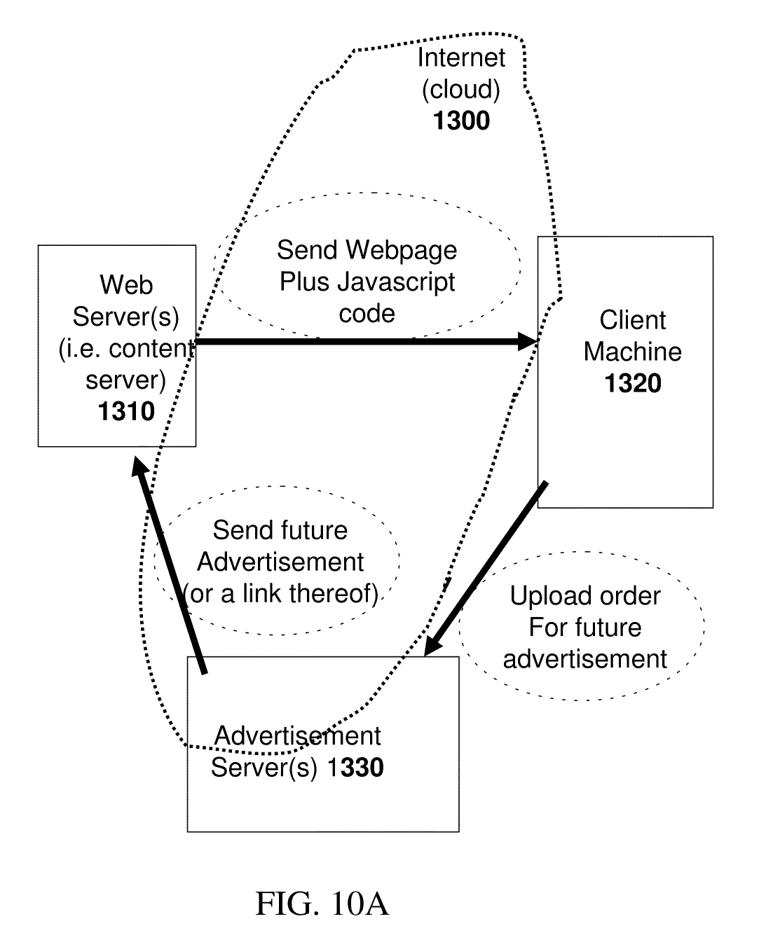

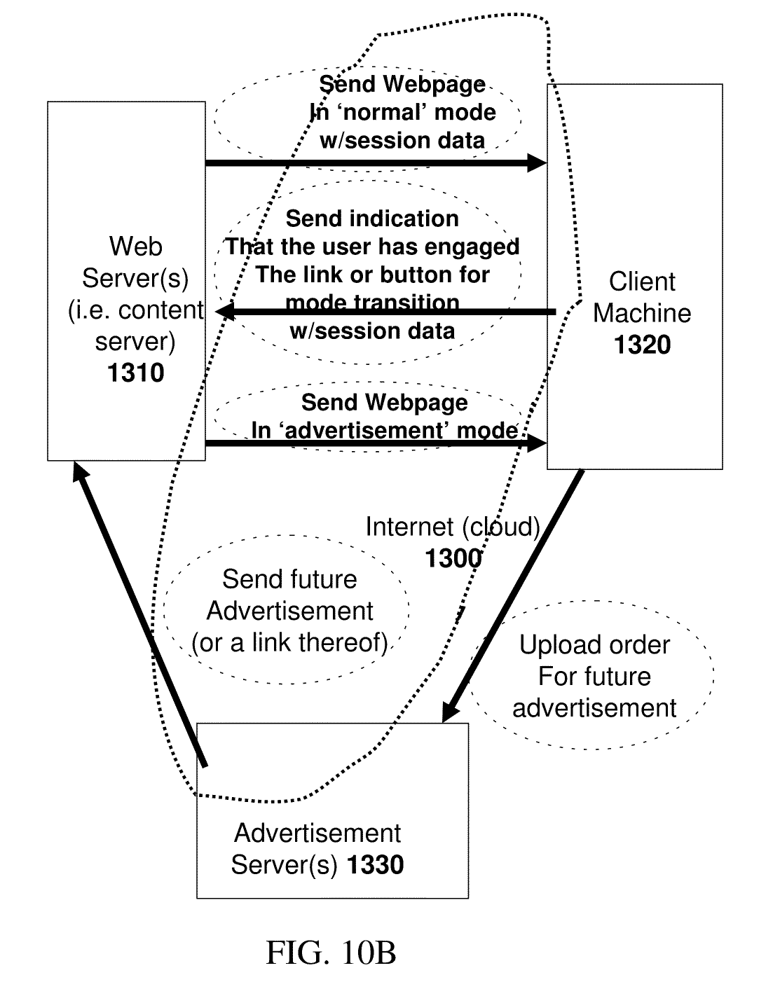

Some embodiments of the present invention (see, for example, FIG. 10A) provide a client computer configured to (i) display the web page (for example, the web page received by the client computer via network interface 1150 and via a switching network such as the Internet from a web server) in ‘normal mode’ on display device 1184; (ii) display a visual user control (for example, a link or a button—see for example, 115 of FIG. 1) on display device 1184 (for example, as part of the web page in ‘normal mode’; (iii) detect a user engagement of the visual user control (for example, when the user clicks the link or button or passing a mouse pointer over the link or button or any other user engagement using user input device 1190); (iv) in response to the detecting of the user engagement, ‘switch over’ to advertising mode (see, for example, FIG. 2A).

Thus, some embodiments of the present invention provide a client computer system comprising: a) a client computer comprising a microprocessor, volatile and/or non-volatile computer memory and a network interface for accessing a computer network; b) a display screen operatively linked to the client computer; c) browser computer code residing in the computer memory; d) a representation of a web page residing within the computer memory, wherein execution of the browser computer code by the microprocessor when the web page is residing within the computer memory: i) causes the display screen to display the web page in normal mode wherein the page comprises content and active advertisements that are displayed in specific advertising spaces within the web page; ii) causes the display screen to display the same web page in an advertiser mode, wherein the page is displayed with the same content and content placement as in said normal mode, while those advertising spaces that are offered for future advertising are shown without their active advertisements and in their exact same placement in the document as in said normal mode, and wherein each advertising space comprises at least a link for guiding an advertiser to a process for self placing an advertisement within said advertising space; and iii) in response to response to a user engagement, by a user control device operatively linked to the client computer, of a visual user control displayed within said web page, effecting a switching between said normal and advertiser modes.

In some embodiments, the visual user control includes a predefined virtual button or link.

It is now disclosed for the first time the aforementioned client computer and the user control device operatively linked to the client computer.

In some embodiments, the user control device is selected from the group consisting of a computer mouse and a computer keyboard.

In some embodiments, execution of the browser computer code by the microprocessor 1180 when the web page is residing within the computer memory (1210 or 1160) is further operative to: v) contingent upon the web page being displayed in the advertiser mode, uploading via the network interface a corresponding advertisement (e.g. an order for future advertising) into a selected advertising space.

In some embodiments, the network interface is configured for interfacing with a switching network.

In some embodiments, at least a portion of the computer code is provided in a browser scripting language (e.g. javascript).

In some embodiments, the web page representation includes at least one of HTML content, javascript code and a java applet.

In some embodiments, one or more techniques described with reference to FIG. 10A are carried out.

### A Discussion of a Server Computer Provided by Some Embodiments

Some embodiments of the present invention (see, for example, FIG. 10B) provide a content web server comprising: a) a server computer comprising a microprocessor, volatile and/or non-volatile computer memory and a network interface for accessing a computer network; and b) computer code residing in the computer memory which when executed by the microprocessor: i) causes the server computer to send a data communication including web page via the computer network to a client device, the data communication including a client-server session identifier, the web page being configured, when loaded by a browser of the client machine, to be displayed in normal mode wherein the page comprises content and active advertisements that are displayed in specific advertising spaces within the web page, the web page including a predefined visual user control for mode switching; and ii) causes the server computer to respond to a communication received via the computer network from the client machine indicating a user engagement of the predefined visual user control on the client device, by sending an instruction to the client machine via the computer network to display the same web page in an advertiser mode such that the page is displayed on the client device with the same content and content placement as in said normal mode, while those advertising spaces that are offered for future advertising are shown on the client device without their active advertisements and in their exact same placement in the document as in said normal mode, and wherein each advertising space comprises at least a link for guiding an advertiser to a process for self placing an advertisement within said advertising space.

Configuring a Content Server

In some embodiments, it is possible to configure a content server by uploading (for example, remotely uploading via a wide-area switching network such as the Internet) computer-readable code onto the content server—for example, PHP code or JSP code or ASP code. The configured content server causes the client device to carry out any technique disclosed herein.

This may make it possible to provide an advertisement service to a number of different content providers.

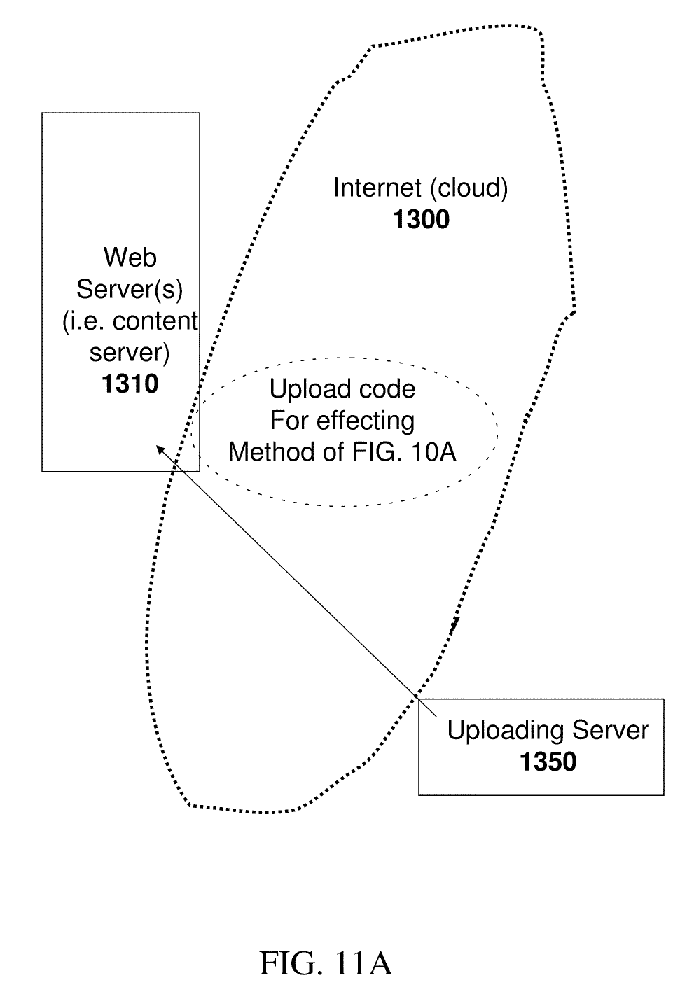

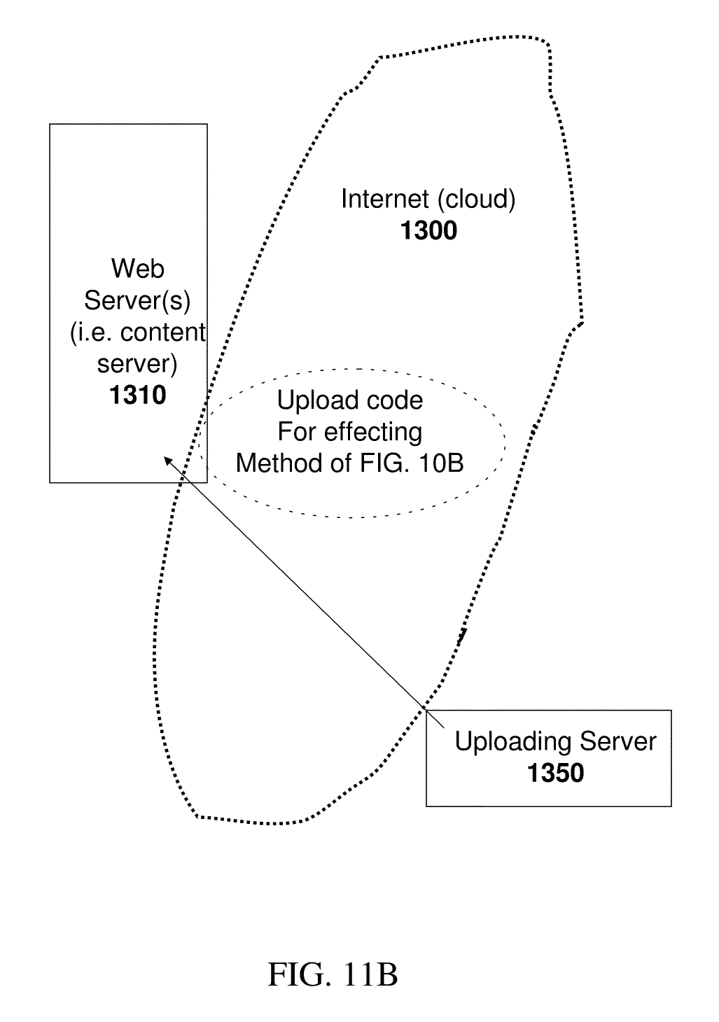

In one example (for example, see FIG. 11A), configuring the content server includes uploading “client-side” code (for example, javascript code which is executing by the client machine after being sent to the client machine from the content server via the computer network—thus, it is possible to embed this javascript code onto web server 1310 so that the web server serves the javascript code to the client machine). In another example (for example, see FIG. 11B), ‘server-side’ code (for example, for managing a session by the content web server with a particular client—for example, using cookies, and sending directives to effect the transition from normal mode to advertising mode, for example, in response to a remotely-detected user engagement of the link or button at the client machine).

In one example (see FIGS. 11A-11B), the “configuring code” (either server side code and/or client side code) may be uploaded to the content server. In an alternative embodiment, this ‘configuring’ computer code is uploaded onto a web proxy machine separate from the content server (NOT SHOWN). The computer code reconfigures content server (or the combination of combination server and one or more additional machines—for example, the content server together with one or more proxies) so that content server causes client computer to display the web page in normal and advertising mode (and allows uploading of advertisement, for example, only when in advertising mode) according to any technique described herein.

The configuration of the content server may include uploading ‘client side code’ (for example, javascript code) to the content server machine(s) or to a web proxy for transitioning by the client machine from normal mode to advertising mode and/or from advertising mode to normal mode.

The “remote configuring” of a content web server may be useful for providing a ‘syndicated advertisement service’ according to one or more of the teachings described herein.

Thus, it is now disclosed for the first time a method (see FIG. 11B) of facilitating advertisement, the method comprising: a) configuring a content web server via a computer network to interact with a client machine by: i) sending a data communication including a web page via the computer network to a client device, the data communication including a client-server session identifier (for example, a cookie), the web page being configured, when loaded by a browser of the client machine, to be displayed in normal mode wherein the page comprises content and active advertisements that are displayed in specific advertising spaces within the web page, the web page including a predefined visual user control for mode switching; and ii) responding to a communication received via the computer network from the client machine indicating a user engagement of the predefined visual user control on the client device, by sending an instruction to the client machine via the computer network to display the same web page in an advertiser mode such that the page is displayed on the client device with the same content and content placement as in said normal mode, while those advertising spaces that are offered for future advertising are shown on the client device without their active advertisements and in their exact same placement in the document as in said normal mode, and wherein each advertising space comprises at least a link for guiding an advertiser to a process for self placing an advertisement within said advertising space.

In some embodiments, the link for guiding the advertiser includes a reference to an advertising server that is different from the content web server, the method further comprising: b) receiving requests for self placement of the advertisement at the advertising server from the client device that are associated with the guiding link, the self-placement request associated with a description of an advertisement; and c) further configuring the content web server to directly serve or to server content linking to the described advertisements of the self-placement request.

In some embodiments, the configuring includes uploading, to the web content, a PHP script for causing the web server to effect steps (i) and (ii).

It is now disclosed for the first time a method of facilitating advertisement, (for example, see FIG. 11A) the method comprising: a) configuring a content web server via a computer network to interact with a client machine by: i) sending a data communication including a web page via the computer network to a client device, the data communication including a web page which when loaded into a browser of a client machine, causes the client machine to: A) display the web page in normal mode wherein the page comprises content and active advertisements that are displayed in specific advertising spaces within the web page; and B) display the same web page in an advertiser mode, wherein the page is displayed with the same content and content placement as in said normal mode, while those advertising spaces that are offered for future advertising are shown without their active advertisements and in their exact same placement in the document as in said normal mode, and wherein each advertising space comprises at least a link for guiding an advertiser to a process for self placing an advertisement within said advertising space; and C) in response to response to a user engagement (for example, detected at on client machine 1320), by a user control device operatively linked to the client computer, of a visual user control displayed within said web page, effecting a switching between said normal and advertiser modes.

### Additional Discussion

FIG. 10A illustrates an exemplary technique for providing multi-mode web pages and for facilitating future advertising where an embedded script is sent to the client for effecting the mode transition. In the example of FIG. 10A, web content server(s) 1310 send the web page including javascript (or some other code intended to be executed on the ‘client side’ by client machine 1320—for example, within the browser on client machine 320) to the client machine via the Internet 1300. When this ‘client-side’ code is executed, (i) a user engagement of a visual control displayed in or together with the web page in ‘normal mode’ is detected on the client for example, by a processing executing the javascript (or other ‘embedded rowser’ code). In response to this ‘client size’ detection, it is possible to effect the mode transition without web server(s) 1310 even ‘knowing’ about the user engagement of the link or button (which may be detected on the client machine 1320).

When in the ‘advertisement mode’ it is possible to upload an order or request for future advertisement, for example, to advertisement server 1330. After the advertiser orders the future advertisement, it is possible for advertisement server(s) 1330 to provide advertisement information to web server(s) 1310 to facilitate the serving of the requested future advertisement.

FIG. 10B illustrates an exemplary technique for providing multi-mode web pages and for facilitating future advertising where a session variables are used by the content server for facilitating the mode transition.

FIGS. 11A-11B illustrate exemplary techniques for configuring the content server to respectively facilitate the technique of FIGS. 10A-10B.

In the example of FIGS. 11A-11B, web serve(s) 1310 is configured, for example, by uploading sever-side or client side code from uploading server 1350 (which may or may not be the same machine as 1330) to web server 1310.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

It is further noted that any of the embodiments described above may further include receiving, sending or storing instructions and/or data that implement the operations described above in conjunction with the figures upon a computer readable medium. Generally speaking, a computer readable medium may include storage media or memory media such as magnetic or flash or optical media, e.g. disk or CD-ROM, volatile or non-volatile storage media such as RAM, ROM, etc. as well as transmission media or signals such as electrical, electromagnetic or digital signals conveyed via a communication medium such as a network and/or wireless links.

Having thus described the foregoing exemplary embodiments it will be apparent to those skilled in the art that various equivalents, alterations, modifications, and improvements thereof are possible without departing from the scope and spirit of the claims as hereafter recited. In particular, different embodiments may include combinations of features other than those described herein. Accordingly, the claims are not limited to the foregoing discussion.

While some embodiments of the invention have been described by way of illustration, it will be apparent that the invention can be put into practice with many modifications, variations and adaptations, and with the use of numerous equivalents or alternative solutions that are within the scope of persons skilled in the art, without departing from the spirit of the invention or exceeding the scope of the claims.

1. Self service advertising method, which comprises: a) displaying a web page in a normal mode, wherein the page comprises content and active advertisements that are displayed in specific advertising spaces within the web page; b) providing the same web page in an advertiser mode, wherein the page is displayed with the same content and content placement as in said normal mode, while those advertising spaces that are offered for future advertising are shown without their active advertisements and in their exact same placement in the document as in said normal mode, and wherein each advertising space comprises at least a link for guiding an advertiser to a process for self placing an advertisement within said advertising space; and c) a predefined virtual button or link within said web page in both said normal and advertiser modes for effecting switching between said normal and advertiser modes.

2. Self service advertising method according to claim 1, further comprising providing the same web page in a publisher mode, wherein the page, including its content, is displayed in the same placement as in said normal mode, while each advertising space within the web page which is offered for advertising comprises a link which guides a publisher to a procedure for defining settings for said advertisement space or for viewing existing settings and statistics relating to the activity of an advertisement which has already been placed by an advertiser within said space, and wherein entrance into the publisher mode is performed by means of a virtual button or link within said web page in the normal or advertiser mode, and wherein a restricted entrance into said publisher mode is allowed only to said publisher by means of a password.

3. Self service advertising method according to claim 1, further comprising a procedure for placing an advertisement by an advertiser within a selected advertising space in said advertiser mode, said procedure comprising one or more of the following: a) uploading by an advertiser a corresponding advertisement into a selected advertising space; b) selecting a schedule for publishing said advertisement; and c) paying for publishing said advertisement within said advertising space during said schedule.

4. Method according to claim 3, further comprising displaying to the advertiser in said advertising mode within each advertising space statistics which relates respectively to past activity of advertisements placed in said advertisement place.

5. Method according to claim 1, further comprising displaying in the advertiser mode within each advertising space the costs for advertising within said advertising space.

6. Method according to claim 3, further comprising offering to an advertiser within an advertisement space in the advertiser mode to submit a bid for placing his advertisement within said advertising space.

7. Method according to claim 2, wherein setting and definitions of advertising spaces that are introduced by the publisher in the publisher mode are exported and embedded within the corresponding web page.

8. Method according to claim 3, further comprising the same web page in a simulation mode, wherein after the step uploading by the advertiser of the advertisement into a selected advertising space, the same page is displayed to the advertiser in said simulation mode with the same content, content placement, advertisements and advertisement placement as in said normal mode, while the newly uploaded advertisement substitutes a corresponding advertisement that exists in the same space in the normal mode, to enable the advertiser to evaluate his new advertisement placement in relation to the other content and advertisement objects within the page.

9. Method according to claim 3, further comprising the defining of one or more of the following:
one or more keywords forming a condition for the display of the advertisement within a web page which contains said keywords;
one or more topics of a web page, forming a condition for the display of the advertisement within a web page whose topics meet said defined topics;
one or more time periods in which said advertisement is displayed.

10. Method according to claim 2, wherein physical setting definitions for each advertisement space are selected from the following: a. advertisement space unique name; b. object type: c. location within the page; d. advertisement space dimensions; e. time sharing of advertisements within the advertisement space; and f. advertising schedule.

11. Method according to claim 2, wherein logical setting definitions for each advertisement space are selected from the following: a. advertiser profile; b. necessity to receive publisher approval; and c. content of the space when being unoccupied by an advertisement.

12. Method according to claim 2, wherein billing setting definitions for each advertisement space are selected from the following: a. pricing method; and b. billing system.

13. Method according to claim 2 wherein the publisher is the site owner.

14. Method according to claim 2 wherein the publisher is an advertising agent.

15. Method according to claim 1, wherein active advertisements within the normal mode appear pale in the advertiser mode in same corresponding advertisement spaces.
